(19) United States
(12) Patent Application Publication
(10) Pub. No.: US 2013/0080198 A1
(43) Pub. Date: Mar. 28, 2013

(54) TIMING SIGNOFF FOR MAXIMUM PROFIT

(71) Applicant: Alexander Y. Tetelbaum, Walnut Creek, CA (US)

(72) Inventor: Alexander Y. Tetelbaum, Walnut Creek, CA (US)

(73) Assignee: LSI Corporation, Milpitas, CA (US)

(21) Appl. No.: 13/246,075

(22) Filed: Sep. 27, 2011

(51) Int. Cl. G06Q 10/00

(52) U.S. Cl. 705/7.11

(57) ABSTRACT

A method of estimating a profit margin for an IC chip includes providing design, manufacturing and financial input data for the IC chip and determining a ratio of performing to manufactured IC chips using chip yields apart from timing. The method of estimating a profit margin also includes characterizing IC chip performance corresponding to clock timing and on-chip-variation (OCV) margins and calculating price and costs corresponding to design, manufacturing and testing of the IC chip. Additionally, the method of estimating a profit margin includes generating a profit margin based on the price and costs. A method of maximizing a profit margin for an IC chip is also included.

### TECHNICAL FIELD

This application is directed, in general, to integrated circuits and, more specifically, to a method of estimating a profit margin for an integrated circuit chip and a method of maximizing a profit margin for an integrated circuit chip.

### BACKGROUND

During timing signoff of a chip design, a value for a timing yield requirement is currently determined on an ad hoc basis, usually without having a scientific or engineering justification, where some high value (e.g., 90 to 99 percent) may customary be chosen. Increasing the timing yield requirement allows more chips to meet a required performance. As a result, design costs and time to market requirements typically increase in response to this high value of timing yield thereby generally reducing profitability. What is needed in the art is a better way to define a timing yield that will allow optimization of profit margin for the chip design.

### SUMMARY

Embodiments of the present disclosure provide a method of estimating a profit margin for an integrated circuit (IC) chip and a method of maximizing a profit margin for an integrated circuit (IC) chip.

In one embodiment, the method of estimating a profit margin for an IC chip includes providing design, manufacturing and financial input data for the IC chip and determining a ratio of performing to manufactured IC chips using chip yields apart from timing. The method of estimating a profit margin also includes characterizing IC chip performance corresponding to clock timing and on-chip-variation (OCV) margins and calculating price and costs corresponding to design, manufacturing and testing of the IC chip. Additionally, the method of estimating a profit margin includes generating a profit margin based on the price and costs.

In another aspect, the method of maximizing a profit margin for an integrated circuit (IC) chip includes providing design, manufacturing and financial input data along with a timing yield having an initial minimum value for the IC chip and establishing a profit margin for the IC chip based on the timing yield having the initial minimum value. The method of maximizing a profit margin also includes incrementing the timing yield, calculating a new profit margin and reporting an optimal timing yield that produces a maximum profit margin for the IC chip.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

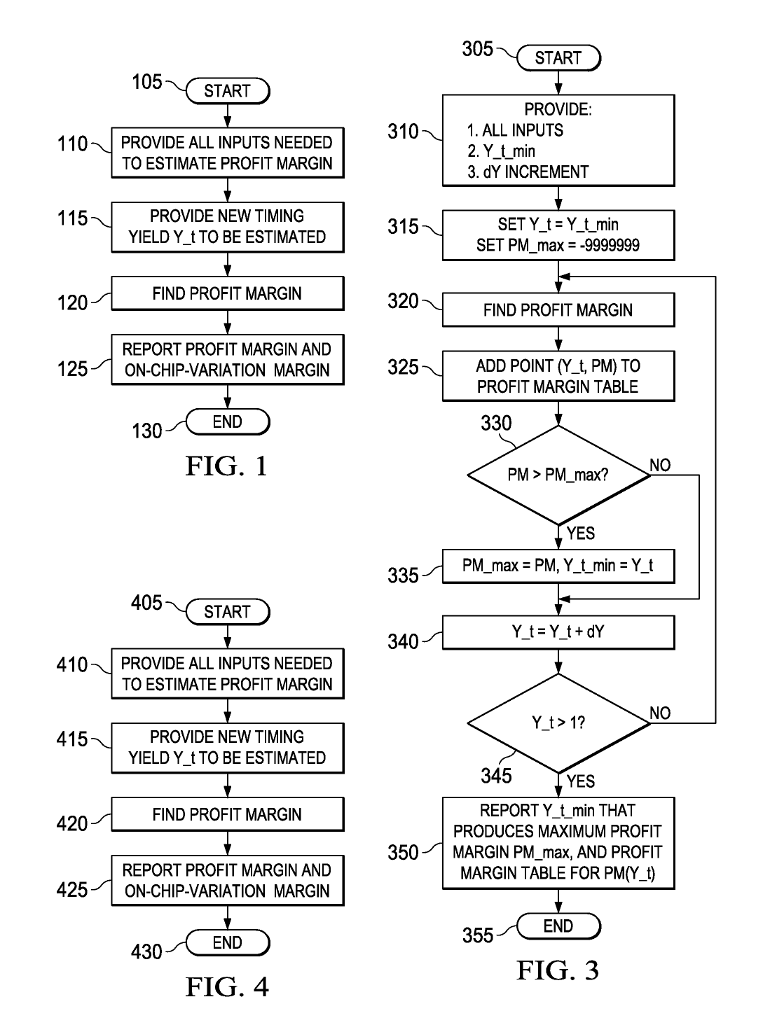

FIG. 1 illustrates a flow diagram of an embodiment of a method of estimating a profit margin corresponding to a new timing yield;

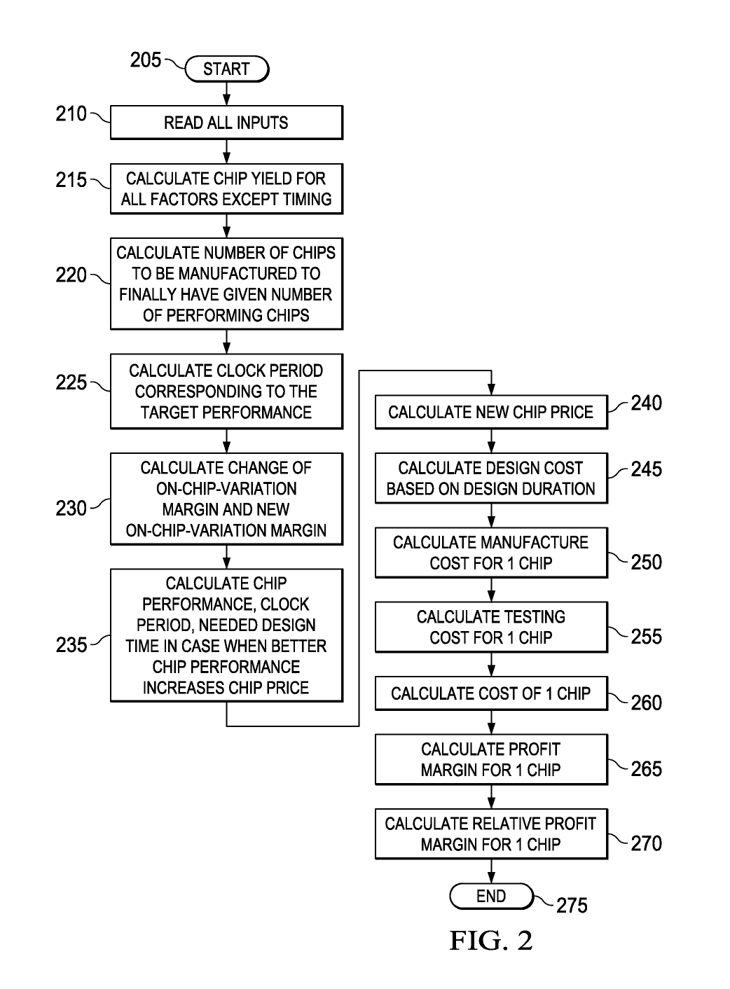

FIG. 2 illustrates a flow diagram of an embodiment of a method of finding a profit margin;

FIG. 3 illustrates a flow diagram of an embodiment of a method of finding a maximum profit margin;

FIG. 4 illustrates a flow diagram of an example of the method of estimating a profit margin corresponding to a new timing yield as discussed with respect to FIG. 1;

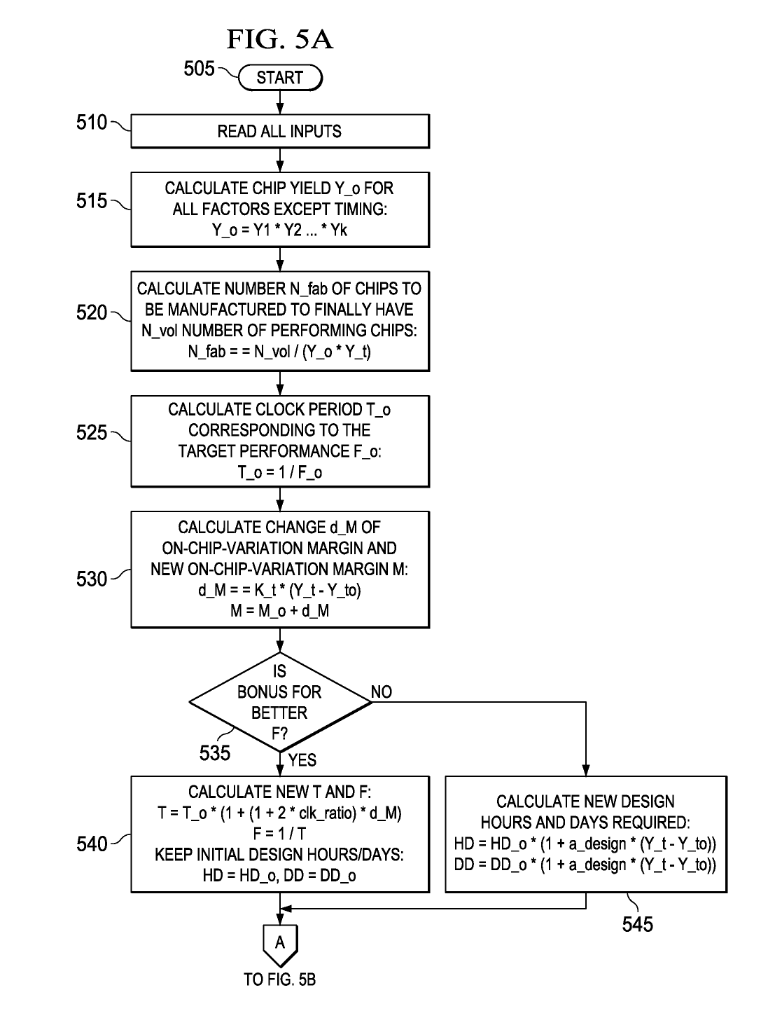

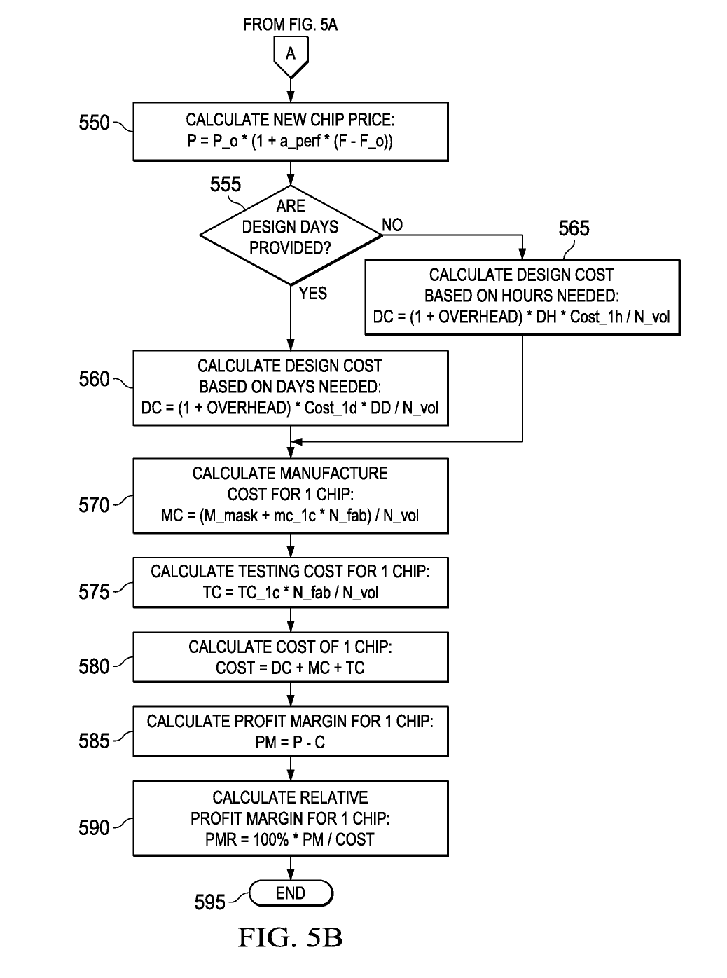

FIG. 5 illustrates a flow diagram of an example of the method of finding a profit margin as discussed with respect to FIG. 2;

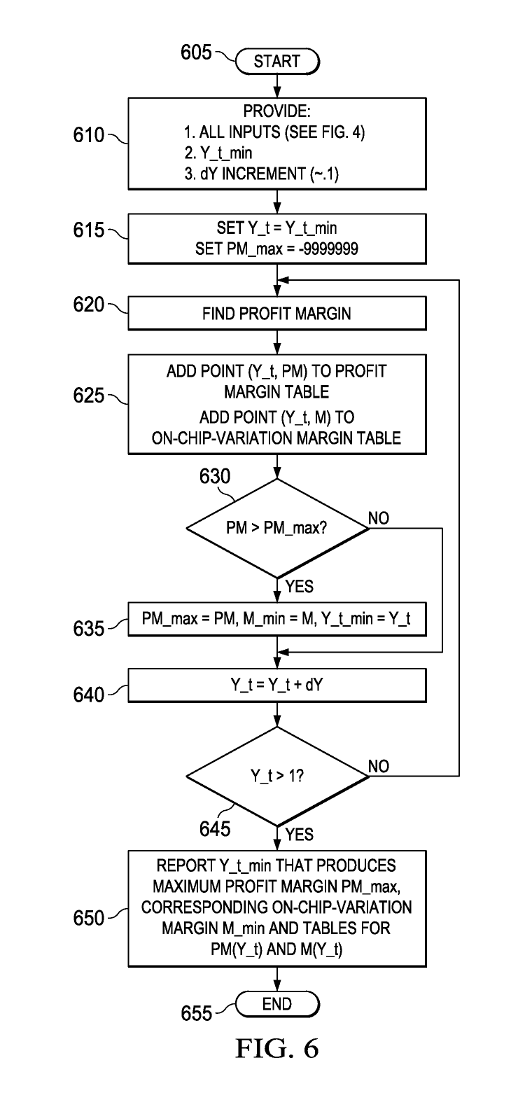

FIG. 6 illustrates a flow diagram of an example of a method of finding a maximum profit margin as discussed with respect to FIG. 3.

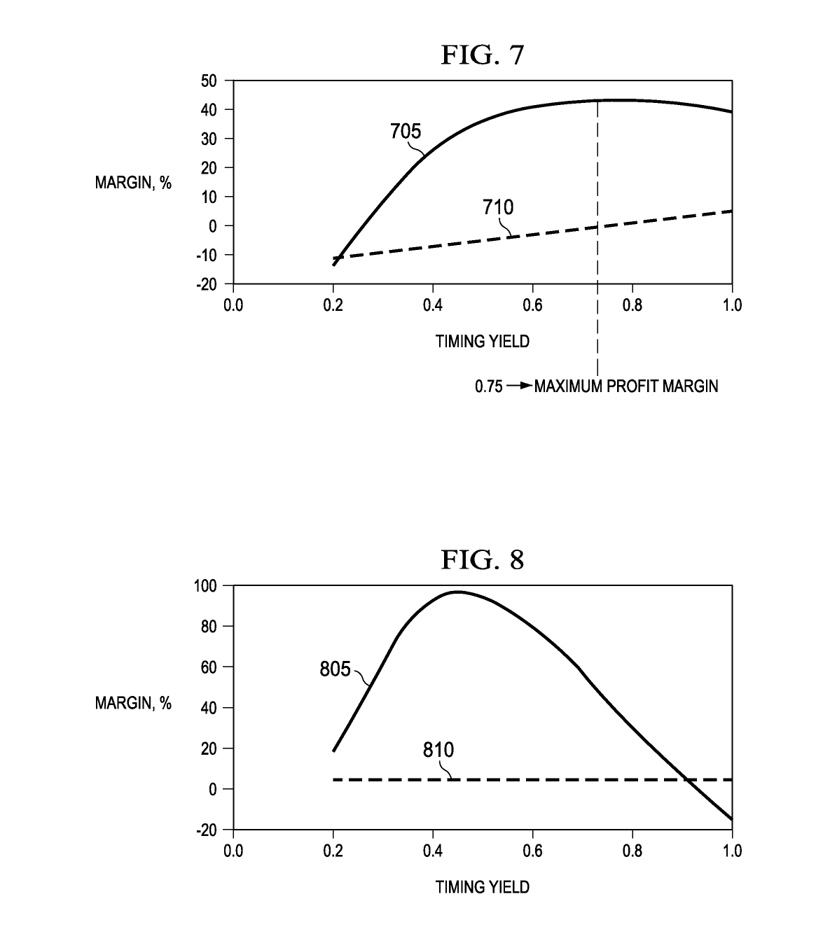

FIG. 7 illustrates an example of graphs showing a profit margin curve and an OCV margin curve as a function of timing yield for a standard product (chip) design.; and

FIG. 8 illustrates another example of graphs showing a profit margin curve 805 and an OCV margin curve 810 as a function of timing yield for a custom product (chip) design.

### DETAILED DESCRIPTION

There are multiple sources of variations for an IC chip (e.g., process, voltage and temperature (PVT) variations), along with electronic design automation (EDA) tool inaccuracies or errors) that justify using additional margins during timing signoff. EDA tools are a category of computer aided design (CAD) tools and may be used to create representations of circuit configurations and the interconnections that couple them together. EDA tools allow verification, performance simulation and testing of designs using a computer without requiring the lengthy and costly process of fabrication.

Increasing on-chip variation (OCV) margins leads to higher timing yield. That is, more chips will have the required performance, but at an increased design cost and duration, since it is more difficult to close timing when margins are larger. Decreasing OCV margins leads to lower timing yield. That is, fewer chips will have the required performance, which increases cost of manufacturing (i.e., more chips need to be produced) and chip testing (to detect non-working chips), but decreases design cost and duration, since it is easier and faster to close timing when margins are small. Therefore, there is an optimum value for the OCV margins (and corresponding timing yield) that will lead to maximizing profit margin.

Embodiments of the present disclosure provide finding an OCV margin and a new timing yield that corresponds to maximizing profit margin for a given chip design. The embodiments and their profit optimization calculations may be carried out within a module that is part of an EDA tool running on a general purpose computer. In general, the optimization may be performed by software running on a general purpose computer. Additionally, graphical examples of profit margin and OCV margin as a function of timing yield are provided.

FIG. 1 illustrates a flow diagram of an embodiment of a method of estimating a profit margin corresponding to a new timing yield. FIG. 1 shows a general method of addressing and solving issues that are related to maximizing a profit margin. The method of FIG. 1 starts in a step 105, and in a step 110, all inputs needed to estimate profit margin are provided. This includes appropriate data concerning design, manufacturing and associated requirements of a semiconductor chip that is under consideration. The inputs also include a current timing yield (Y_to) requirement and a current On-Chip-Variation (OCV) margin that is used in a typical timing signoff.

In a step 115, a new timing yield (Y_t) to be estimated is provided. In a step 120, a profit margin is found employing the method of FIG. 2. In a step 125, the profit margin and an OCV margin are reported. Actually, the method of FIG. 1 reports or returns absolute and relative profit margins as well as a new OCV margin that is needed to provide the new timing yield Y_t. The method of FIG. 1 ends in a step 130.

FIG. 2 illustrates a flow diagram of an embodiment of a method of finding a profit margin. The method of FIG. 2 is a generalized method of finding profit margin. The method of FIG. 2 starts in a step 205, and in a step 210, all inputs as indicated in FIG. 1 are read or provided. In a step 215, chip yield for all factors except timing is calculated. There are other factors (e.g., chip defects or high leakage) that decrease chip yield. The step 215 calculates the chip yield for all factors (excluding timing yield) taking into account these inputs.

In a step 220, a number of chips to be manufactured is calculated to have a given number of performing chips. Since not all chips will have a required performance (i.e., yield is never equal to 100 percent due to defects, etc.), more chips than are required by a customer need to be manufactured. The step 220 does this calculation taking into account all yield values. In a step 225, a clock period corresponding to a target performance frequency (F) is calculated. Assuming that the target performance frequency F (equal to an operating frequency) is given, the step 225 calculates the corresponding clock period for the clock network.

In a step 230, a change of OCV margin and a new OCV margin are calculated. The step 230 estimates a change in OCV margin if a new timing yield is used instead of the current timing yield (both are inputs). In a step 235, chip performance, clock period and needed design time are calculated for a case when better chip performance increases chip price. The step 235 accomplishes all of these estimations in case the input options specify increasing the final chip performance, because the customer is willing to pay a higher price for such increased performance.

In a step 240, a new chip price is calculated. The step 240 calculates the new chip price taking into account all inputs and possible increases in price due to better performance. In a step 245, a design cost is calculated based on design duration. The step 245 estimates a total design cost that is based on design duration and corresponding inputs providing design cost components. In a step 250, a manufacture cost for one chip is calculated. The step 250 estimates the manufacture cost for one chip that is based on timing yield and corresponding inputs providing manufacture cost components.

In a step 255, a testing cost for one chip is calculated. The step 255 estimates the testing cost for one chip that is based on timing yield and corresponding inputs that provide testing cost components. In a step 260, a cost of one chip is calculated. The step 260 calculates the cost of one chip based on design, manufacture and testing costs. In a step 265, a profit margin for one chip is calculated. The step 265 estimates absolute profit margin (e.g., in US dollars) for one working chip based on the chip price and the chip cost. In a step 270, a relative profit margin for one chip is calculated. The step 270 estimates relative profit margin (e.g., in percent) for one working chip based on the absolute profit margin and chip cost. The method of FIG. 2 ends in a step 275.

FIG. 3 illustrates a flow diagram of an embodiment of a method of finding a maximum profit margin. The method of FIG. 3 is an example of a generalized method of finding profit margin. The method of FIG. 3 starts in a step 305 and in a step 310, all inputs are provided (the same as in FIG. 1 and FIG. 2) as well as additional inputs that provide a minimum timing yield Y _t _min as a starting point and a timing yield increment dY for each timing yield increase that will be analyzed.

In a step 315, the method sets Y_t=Y_t_min and PM_max=−9999999. The step 315 thereby initializes a current value for timing yield and maximum profit margin. Note that the value of −9999999 is just an example of a very small (negative) margin. It may be any very small number that is known to be less than any realistic margin. In a step 320, the method of FIG. 2 is employed to find a profit margin, and in a step 325, a point (Y_t, PM) is added to a profit margin table. The step 325 adds one more (current) point of the timing yield and profit margin to the profit margin table.

In a decisional step 330, it is determined if the profit margin is greater than a maximum value of profit margin (i.e., PM>PM_max?) The decisional step 330 determines if the current profit margin is more than previously memorized. If so, a step 335 provides new maximum values for profit margin and corresponding timing yield (i.e., PM_max=PM and Y_t_min=Y_t). Note that now, the notation Y_t_min actually means an optimum timing yield rather than the initial value for timing yield provided in the earlier steps. If not, or at the conclusion of the step 335, a step 340 increments the current timing yield by the input increment value (i.e., Y_t=Y_t+dY). In the step 340, the new value of Y_t will become the current value for timing yield and will be use in the next iteration.

In a decisional step 345, it is determined if the current timing yield is greater than a maximum possible yield of 1.0 (i.e., Y_t>1?). If not, the method returns to the step 320 for continued processing. If so, a step 350 reports Y_t_min that produces maximum profit margin PM_max, and profit margin table for PM(Y_t). The step 350 reports all outputs of the method. The method of FIG. 3 ends in a step 355. The following FIGS. 4, 5 and 6 provide a somewhat more detailed example for the general methods of FIGS. 1, 2 and 3.

FIG. 4 illustrates a flow diagram of an example of the method of estimating a profit margin corresponding to a new timing yield as discussed with respect to FIG. 1. The method of FIG. 4 starts in step 405 and provides more detail for a step 410 wherein all inputs needed to estimate a profit margin are provided in a Table 1. Table 1 illustrates examples of appropriate data concerning design, manufacturing and associated requirements of a semiconductor chip that is under consideration.

TABLE 1
Example of Inputs Needed to Find Profit Margin

N_vol = number of chips needed (volume) that must work.
Y_to = Current Timing yield used in signoff
Y1 = Timing yield due to defects
Y2 = Timing yield due to leakage, etc.
M_o = Current OCV margin, %
F_o = Target frequency (chip performance), MHz
Bonus (Yes or No) for achieving higher F than F_o
P_o = Market price for chip with F_o performance
a_perf = Coefficient for price increase
K_t = Empirical coefficient (~20) for OCV margin change
clk_ratio = Ratio of Clock path delay to Clock period
Cost_1d = Cost of one day of design
DD_o = Days of design for signoff at F_o frequency
Cost_1h = Cost of one hour of design
DH_o = Hours of design for signoff at F_o frequency
Overhead = Overhead design cost coefficient
a_design = Coefficient for design duration change
M_mask = Cost of producing all masks for chip manufacturing
MC_1c = Cost of manufacturing of 1 chip
MC_1c = Cost of manufacturing of 1 chip
TC_1c = Cost of testing of 1 chip

In a step 415, a new timing yield (Y_t) to be estimated is provided. In a step 420, a profit margin is found employing the method of FIG. 2. In a step 425, the profit margin and an OCV margin are reported. Actually, the method of FIG. 4 reports or returns absolute and relative profit margins as well as a new OCV margin that is needed to provide the new timing yield Y_t. The method of FIG. 4 ends in a step 430.

FIG. 5 illustrates a flow diagram of an example of the method of finding a profit margin as discussed with respect to FIG. 2. The method of FIG. 5 starts in a step 505 and in a step 510, appropriate data concerning design, manufacturing and associated requirements of a semiconductor chip are provided as recorded in Table 1 above. In a step 515, a chip Yield Y_o for all factors except timing is calculated (i.e., Y_o=Y1*Y2* . . . *Yk). Recall that there are other factors (e.g., chip defects or high leakage) that decrease chip yield. These factors 1, 2, . . . k have corresponding yields Y1, Y2, . . . , Yk. The step 515 calculates the chip yield Y_o for all this factors (other than timing yield) taking into account the inputs Y_o=Y1*Y2* . . . *Yk.

In a step 520, a number N_fab of chips to be manufactured to provide N_vol number of performing chips (i.e., chips having a required performance) is calculated (i.e., N_fab=N_vol/(Y_o*Y_t)). Since not all chips will be performing (a yield is never equal to 1.0), more chips (N_fab) are manufactured than are required (N_vol) by a customer. This step 520 performs this calculation taking into account all yield values, where Y_o*Y_t is the total yield.

In a step 525, a clock period T_o is calculated corresponding to the target performance F_o: T_o=1/F_o. Assuming that target performance F_o (equal to an operating frequency F_o) is given, the block calculates the corresponding clock period for the clock network: T_o=1/F_o. In a step 530, a change d_M of OCV margin and a new OCV margin M are calculated (d_M==K_t*(Y_t−Y_to), M=M_o+d_M). The step 530 estimates a change d_M in OCV margin M_o if a new timing yield Y_t is used instead of a current timing yield Y_to (both are inputs) (d_M==K_t*(Y_t−Y_to), where K_t is an input coefficient). The step 530 also calculates the new OCV margin M, where M=M_o+d_M.

In a decisional step 535, it is determined if there is a bonus for a better F. If so, a step 540, calculates a new T & F (i.e., T=T_o*(1+(1+2*clk_ratio)*dM), F=1/T and initial design hours/days are kept(HD=HD_o, DD=DD_o). The step 540 does all of these estimations in case the input option (there is a bonus (higher chip price) for chip with higher performance) specifies that there is interest to increase the final chip performance, because the customer is willing to pay a higher price for such increased performance. In this case, the step 540 calculates a clock period T=T_o*(1+(1+2*clk_ratio)*d_M and a new chip performance F=1/T, where clk_ratio is an input. There is no change to design hours or days needed for the design.

If not, a step 545 calculates new design hours & days required (HD=HD_o*(1+a_design*(Y_t−Y_to)), DD=DD_o*(1+a_design*(Y_t−Y_to)). In case there is no bonus (i.e., a higher chip price) for a chip with higher performance, the step 545 calculates new values for needed design time HD=HD_o*(1+a_design*(Y_t−Y_to)) [hours needed for design] and DD=DD_o*(1+a_design*(Y_t−Y_to)) [days needed for design], where a design is an input coefficient. In a step 550, a new Chip Price is calculated (P=P_o*(1+a_perf*(F−F_o)). The step 550 calculates the new chip price P==P_o*(1+a_perf*(F−F_o)) taking into account needed inputs and a possible increase in price due to better performance.

In a decisional step 555, it is determined if design days are provided. If so, a step 560 calculates design dost based on days needed (DC=(1+overhead)*Cost_{—}1d*DD/N_vol). If design days is provided as an input, the step 555 estimates the total design cost DC=(1+overhead)*Cost_{—}1d*DD/N_vol that is based on design duration in days and corresponding inputs providing design cost components. If not, a step 565 calculates design cost based on hours needed (DC=(1+overhead)*Cost_{—}1h*DH/N_vol). If design hours are provided as an input, the step 565 estimates the total design cost (DC=(1+overhead)*Cost_{—}1d*DH/N_{'}vol) that is based on design duration in hours and corresponding inputs providing design cost components.

A step 570 calculates manufacture cost for one chip (MC=(M_mask+MC_{—}1c*N_fab)/N_vol). The step 570 estimates the manufacture cost (MC=(M_mask+MC_{—}1c*N_fab)/N_vol) for one chip that is based on N_fab and corresponding inputs providing manufacture cost components. A step 575 calculates testing cost for one chip (TC=TC_{—}1c*N_fab/N_vol). The step 575 estimates the testing cost (TC=TC_{—}1c*N_fab/N_vol) for one chip that is based on N_fab and corresponding inputs providing testing cost components.

A step 580 calculates a cost of one chip (Cost=DC+MC+TC). The step 580 calculates the cost of one chip based on design, manufacture and testing costs. A step 585 calculates a profit margin for one chip (PM=P−C). The step 585 estimates an absolute profit margin (e.g., PM=P−C in US dollars) for one working chip based on the chip price and the chip cost. A step 590 calculates relative profit margin for one chip (PMR=100%*PM/Cost). The step 590 estimates relative profit margin (e.g., PMR=100%*PM/Cost (in percent)) for one working chip based on the absolute profit margin and chip cost. The method of FIG. 5 ends in a step 595.

FIG. 6 illustrates a flow diagram of an example of a method of finding a maximum profit margin. The method of FIG. 6 is a more detailed example of the method of FIG. 3. The method of FIG. 6 starts in a step 605 and in a step 610, appropriate data concerning design, manufacturing and associated requirements of a semiconductor chip are provided as recorded in Table 1 above. The step 610 reads or provides the inputs of Table 1 and additional inputs that provide minimum timing yield Y_t_min as a starting point and a yield increment dY (e.g., an increment value of −0.1) for each timing yield increase that will be analyzed.

A step 615 sets Y_t=Y_t_min and PM_max=−9999999. The step 615 initializes a current value for timing yield and maximum profit margin. Note that −9999999 is just an example of a very small (negative) margin. It may be any small number that is less than any realistic margin. In a step 620, the method of FIG. 4 is employed to find a profit margin and in a step 625, points (Y_t, PM) are added to a profit margin table, and points (Y_t, M) are added to an OCV margin table. The step 625 is adding one more (current) point of the timing yield and profit margin to the profit margin table. It is also adding one more (current) point of the timing yield and profit margin to the OCV margin table.

In a decisional step 630, it is determined if PM>PM_max. The decisional step 630 checks if a current profit margin is more than previously memorized. If so, a step 635 sets PM_max=PM, M_min=M and Y_t_min=Y_t (now it is an optimal current yield). It memorizes a new maximum value for profit margin and corresponding minimum values for OCV margin and timing yield. If not, or at the conclusion of the step 635, a step 640 determines if Y_t=Y_t+dY. The step 640 increments the current timing yield by the input increment value. The new value of Y_t will become the current value for the timing yield and will be used in the next iteration.

In a decisional step 645, it is determined if Y_t>1. The decisional step 645 checks if current timing yield is more than a maximum possible yield of 1.0. If not, the method returns to the step 620. If so, a step 650 reports a Y_t_min that produces a maximum profit margin PM_max, a corresponding OCV margin M_min and tables for PM(Y_t) & M(Y_t). The step 650 reports all outputs of the method. The method of FIG. 6 ends in a step 655.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

FIG. 7 illustrates an example of graphs showing a profit margin curve 705 and an OCV margin curve 710 as a function of timing yield for a standard product (chip) design. Each product may have its own individual characteristics and graph, but this example of the profit margin and OCV margin curves 705, 710 provides a typical case for the standard product (chip) design. There is a relative large interval of timing yield (from about 0.6 to about 0.95) where there is a profit margin of at least 40 percent. This indicates that some other design metric can be used to select timing yield. However, if maximizing profit is a major objective, then a timing yield of about 0.75 may be selected. As mentioned previously, the method of FIG. 3 or the method of FIG. 6 will report a corresponding OVC margin to be used as well as other metrics including chip performance, design time, etc.

FIG. 8 illustrates another example of graphs showing a profit margin curve 805 and an OCV margin curve 810 as a function of timing yield for a custom product (chip) design. Again, each product may have its own individual characteristics and graphs, and this example of the profit margin and OCV margin curves 805, 810 provides a typical case for the custom product (chip) design. Here, there is a relatively small interval of timing yield (from about 0.4 to about 0.6) having a profit margin of at least 80 percent. If a smaller profit margin is acceptable, then a higher yield may be obtained and some other design metrics may be used to select timing yield. However, if maximizing profit is a major objective, then a timing yield of about 0.5 may be selected.

Those skilled in the art to which this application relates will appreciate that other and further additions, deletions, substitutions and modifications may be made to the described embodiments.

What is claimed is:

1. A method of estimating a profit margin for an integrated circuit (IC) chip, comprising:
providing design, manufacturing and financial input data for the IC chip;
determining a ratio of performing to manufactured IC chips using chip yields apart from timing;
characterizing IC chip performance corresponding to clock timing and on-chip-variation (OCV) margins;
calculating price and costs corresponding to design, manufacturing and testing of the IC chip; and
generating a profit margin based on the price and costs.

2. The method as recited in claim 1 wherein the characterizing includes calculating a clock period corresponding to a target performance of the IC chip.

3. The method as recited in claim 1 wherein the characterizing includes calculating a new OCV margin employing an incremental OCV margin value.

4. The method as recited in claim 1 wherein the characterizing includes calculating needed design time when improving the IC chip performance increases a price of the IC chip.

5. The method as recited in claim 1 wherein the calculating includes design costs based on design duration.

6. The method as recited in claim 1 wherein the calculating includes manufacturing costs corresponding to one IC chip.

7. The method as recited in claim 1 wherein the calculating includes testing costs corresponding to one IC chip.

8. The method as recited in claim 1 wherein the calculating includes a total cost for one IC chip.

9. The method as recited in claim 1 wherein the generating includes calculating a profit margin for one IC chip.

10. The method as recited in claim 9 wherein the profit margin is a relative profit margin.

11. A method of maximizing a profit margin for an integrated circuit (IC) chip, comprising:
providing design, manufacturing and financial input data along with a timing yield having an initial minimum value for the IC chip;
establishing a profit margin for the IC chip based on the timing yield having the initial minimum value;
incrementing the timing yield and calculating a new profit margin;
reporting an optimal timing yield that produces a maximum profit margin for the IC chip.

12. The method as recited in claim 11 wherein the providing includes providing a timing yield increment.

13. The method as recited in claim 11 wherein the establishing includes testing the profit margin for a maximum profit margin.

14. The method as recited in claim 11 wherein the incrementing includes providing a new timing yield that is less that one.
